(19) United States
(12) Patent Application Publication
(10) Pub. No.: US 2002/0112415 A1
(43) Pub. Date: Aug. 22, 2002

(54) Garden edging system

(76) Inventor: Merlin Randal Eakin, Groves, TX (US)

Correspondence Address: GUY VINCENT MANNING, P.E., 405 PARK PLAZA, 2501 PARKVIEW DRIVE, FORT WORTH, TX, 76102, US

(21) Appl. No.: 10/056,690

(22) Filed: Jan. 24, 2002

Related U.S. Application Data
(60) Provisional application No. 60/264,004, filed on Jan. 24, 2001.

(51) Int. Cl. E02D 27/00; A01G 1/00

(52) U.S. Cl. 52/102; 47/33

(57) ABSTRACT

A bordering system comprises blocks of plastic, masonry or other materials which couple end to end to create an aesthetically pleasing boundary or wall in front of flower beds, fish ponds, property boundaries and the like. The blocks have sufficient thickness such that they stand upright without external bracing. A cylindrical post integral with one end of each block mates with a corresponding scallop on the opposite end of the adjacent block to link adjacent blocks and maintain stability. The blocks may be pivoted relative to each other to almost any angle either side of their common centerline, so the border maintains its interlocking and aesthetic appeal around curves and corners. For inside corners, a specialized filler block assures proper interlocking.

### BACKGROUND OF THE INVENTION

1. Field of the Invention

This invention relates to bordering apparatus generally, and particularly to a bordering or edging system for gardens, yards and the like. More particularly, this invention relates to masonry and other blocks arranged end to end to form decorative perimeters around flower beds, ponds and similar outdoor and indoor displays. Still more particularly, this invention relates to an interlocking interface between adjacent blocks which maintains an aesthetically pleasing transition as well as transverse stability.

2. Description of Related Art

Garden edging systems are ubiquitous. Such systems typically define a distinct, tidy border to a flower bed, sidewalk or the like, and in some cases serve to confine built up soil behind the resulting barrier. They range from simple plastic or metallic sheets in six inch high rolls, supported by surrounding soil when their lower edges are pushed into the ground, to larger, free-standing blocks of masonry or plastic adapted to rest on substantial bottom edges, either partially sunken or not.

For such individual block systems, longitudinal alignment of adjacent blocks may be problematic. Particularly where soil mounds against one side without an offsetting mass on the other, the top edges and ends of adjacent blocks easily become misaligned. Some systems provide end to end interfaces such as clamps, notches and mortise-and-tenon style couplings to prevent relative movement between adjacent blocks. For straight runs of blocks, such end interfaces serve the purpose reasonably well. For curved borders and corners, however, visible edge notches aesthetically may be less than ideal. Further, the interlocking features often fail to work in such cases. A need exists for an interlocking system for bordering blocks which remains functional and aesthetically acceptable when used on curved and angled borders and corners.

### SUMMARY OF THE INVENTION

Accordingly, it is an object of this invention to provide a bordering system with interlocking ends.

It is another object of this invention to provide a bordering system that maintains alignment and stability around curves and corners.

It is another object of this invention to provide interlocking blocks for a bordering system that achieve such interlocking through devices integral to the blocks themselves, without the need for separate pins, pegs clamps or other separate securing devices.

It is another object of this invention to provide a bordering system which is aesthetically pleasing in various configurations.

It is yet another object of this invention to provide a bordering system which may be used in various applications, such as flower beds, fish ponds, fences and other island-like objects.

The foregoing and other objects of this invention are achieved by providing a bordering system comprising blocks of plastic, masonry or other materials, the blocks having sufficient thickness such that they stand upright without external bracing. The blocks couple end to end to create an aesthetically pleasing boundary or wall in front of flower beds, fish ponds, property boundaries and the like. A cylindrical post integral with one end of each block mates with a corresponding scallop on the opposite end of the adjacent block to link blocks and maintain stability. The blocks may be pivoted relative to each other to almost any angle either side of their common centerline, so the border maintains its interlocking and aesthetic appeal around curves and corners. For inside corners, a specialized filler block assures proper interlocking.

### BRIEF DESCRIPTION OF THE DRAWINGS

The novel features believed characteristic of the present invention may be set forth in one or more appended claims. The invention itself, however, as well as a preferred mode of use and further objects and advantages thereof, will best be understood by reference to the following detailed description of an illustrative embodiment when read in conjunction with the accompanying drawings, wherein:

FIG. 1 shows the bordering system of the present invention arrayed along a cornering sidewalk in front of a shrubbery bed.

FIG. 2 is a front elevational view of a single block of the bordering system of FIG. 1.

FIG. 3 is a rear elevational view of the block of FIG. 2.

FIG. 4 is a top plan view of the block of FIG. 2.

FIG. 5 is a right side elevational view of the block of FIG. 2 as viewed in FIG. 3.

FIG. 6 is a left side elevational view of the block of FIG. 2 as viewed in FIG. 3.

FIG. 7 is a plan view detailing an interface between two blocks in FIG. 1 sharing a common centerline.

FIGS. 8-10 detail variations in angle between the blocks shown in FIG. 7.

FIG. 11 shows in perspective details of the filler block in use on the rear side of the corner marked “A” in FIG. 1.

FIGS. 12 and 13 show in plan view variations in centerline angles of the blocks shown in FIG. 11, including use of the filler block.

### DETAILED DESCRIPTION OF A PREFERRED EMBODIMENT

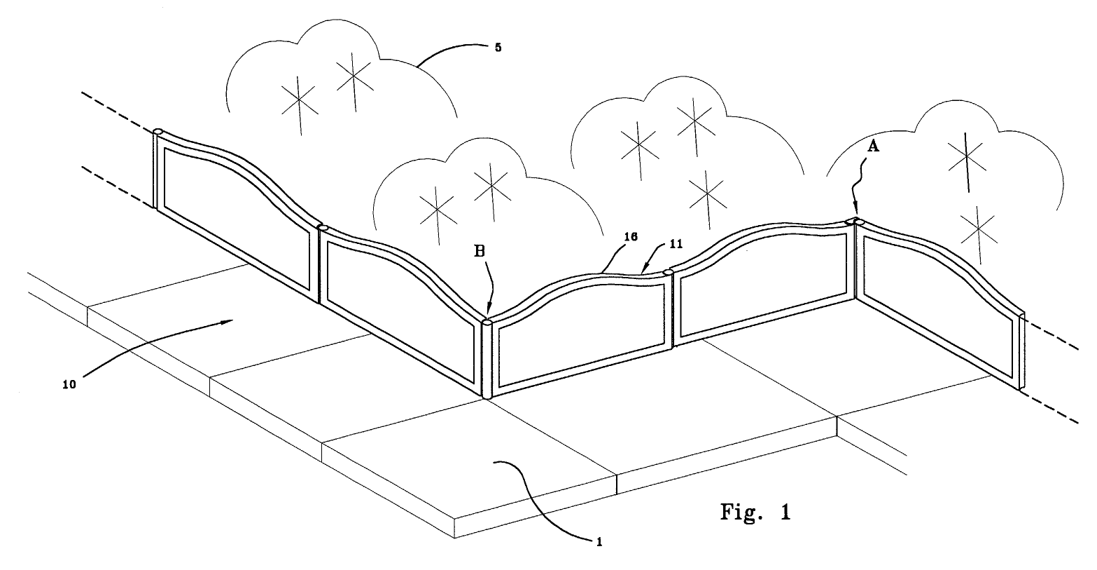

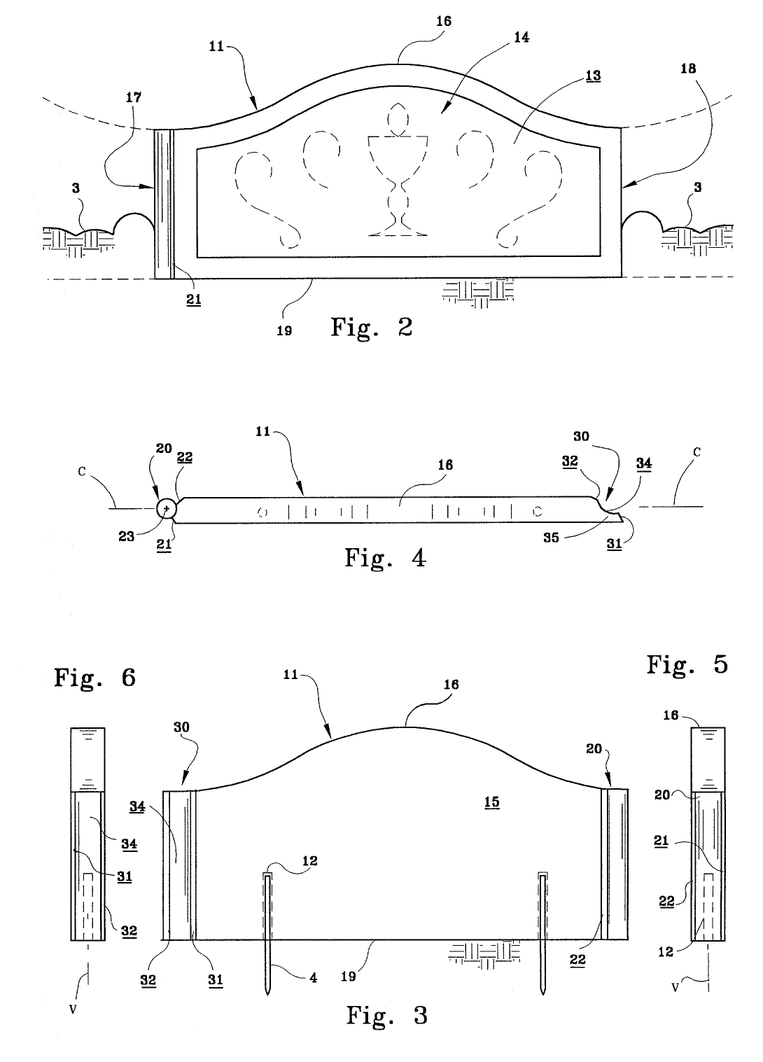

With reference now to the figures, and in particular to FIGS. 1 and 2, bordering system 10 of the preferred embodiment comprises a plurality of masonry blocks 11 arrayed end to end along sidewalk 1 in front of shrubbery 5. Bordering system 10 provides an aesthetically pleasing retaining wall for soil 3 under shrubbery 5 which may be mounded above sidewalk 1. Blocks 11 maintain this attractive boundary while following gradual curves (not shown) and turning abrupt corners, such as inside corner A and outside corner B. Blocks 11 include decoration 14 on their front faces (FIG. 2) and smooth, sinusoidal top perimeters or cornices 16. In the preferred embodiment, decoration 14 comprises a uniformly embossed pattern limited to the boundaries of front face 13. One having ordinary skill in the art will recognize, however, that decorations 14 could be any variations thereof, including painted or printed patterns and other thickness variations such as sculptures, scallops, filigrees and other aesthetic and/or functional embellishments without departing from the spirit and scope of the present invention.

Turning now to also to FIGS. 3-6, each block 11 comprises a slab of masonry substantially uniform in thickness along its longitudinal centerline C and vertical centerline V. Each block 11 has a varying height profile, resulting in cornice 16, disposed on its top edge. Each block 11 further comprises rear face 15 and left and right ends 17, 18, respectively, as viewed in FIG. 2. Bottom edge 19 of blocks 11 may be embedded within soil 3 for stability and as a retaining wall for soil 3. Alternately, bottoms 19 may be flush with the surface of soil 3 or other substrate upon which bottom 19 rests. One having ordinary skill in the art will recognize that all such configurations are within the spirit and scope of the invention. Bores 12 may extend into block 11 from bottom 19 and receive spikes 4 driven into the ground and serving as braces or anchor pins or anchor bolts to enhance lateral stability of blocks 11. Spikes 4 are most useful where, for example, long, straight runs of bordering system 10 coincide with a large load disparity between front side 13 and rear side 15 caused by soil 3 or other masses mounding against blocks 11. Spikes 4 may embed directly into soil 3 or protrude from a foundation (not shown) inlaid into soil 3 for supporting bordering system 10.

An interlocking system keeps adjacent blocks 11 in alignment with one another. It comprises cylindrical post 20 disposed vertically along left end 17 and adapted to mate with corresponding scallop 30 on opposite end 18 of adjacent block 11. Post 20 preferably has a uniform cross section or diameter, and preferably shares a common centerline with scallop 30 and blocks 11. Axis 23 of post 20 coincides with a projected vertical axis of scallop 30 when post 20 is nested properly within scallop 30.

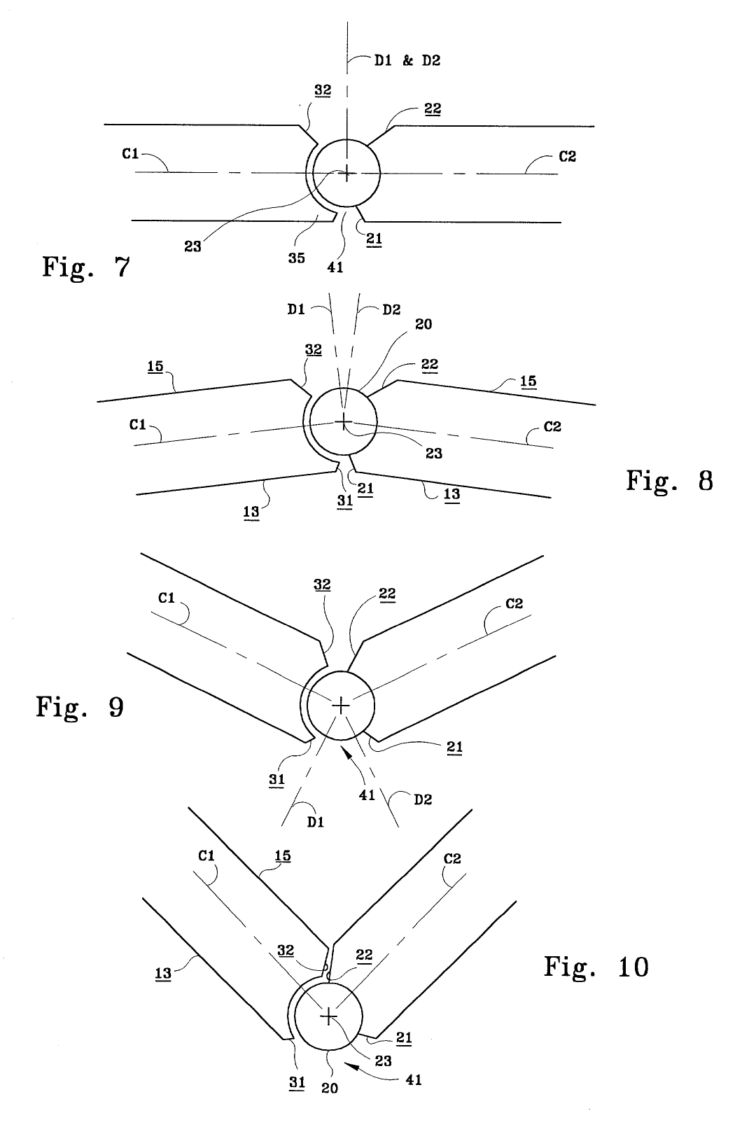

Flange 35 terminates in bevel 31 to extend front face 13 of block 11 partially in front of post 20 of adjacent block 11. Specifically, when two adjacent blocks 11 are butted end to end with no angle between their respective centerlines C₁ and C₂ (FIG. 7), flange 35 extends in front of post 20 enough that bevel 31 almost meets bevel 21, thereby creating the illusion of a continuous front face 13 between two adjacent blocks 11. In this fashion, the aesthetically pleasing appearance of bordering system 10 is maximized.

FIGS. 7-10 detail in plan view the interface between scallop 30 and post 20 when centerlines C₁ and C₂ intersect at various angles when border system 10 follows a curvilinear path. When two adjacent blocks 11 pivot relative to each other, their centerlines C₁ and C₂ form an angle the apex of which coincides with axis 23, regardless of whether front faces 13 pivot toward (FIG. 8) or away from (FIGS. 9 and 10) each other. This occurs for all offsets up to where bevels 21 and 31 (FIG. 8) or bevels 22 and 32 (FIG. 10) meet. By this arrangement, blocks 11 may progress around a very gradual curve or a curve of substantial arc without losing the continuous interface between blocks 11. This is achieved without pins, clamps or other separate retaining means between individual blocks 11.

As best seen in FIG. 7, bevel 21 adjacent post 20 is recessed angularly toward front face 13 from plane D₂, perpendicular to centerline C₂ through axis 23. This recess allows flange 35 on adjacent block 11 to advance around post 20 until bevels 21, 31 meet, forming a substantially obtuse interior angle between centerlines C₁ and C₂. This in turn permits bordering system 10 to follow an inside, curved perimeter of convenient radius while maintaining the visual continuity of a straight run (FIG. 7). When centerlines C₁ and C₂ are offset in the other direction (FIG. 9), gap 41 opens between bevels 31 and 21. Rather than causing a breach of bordering system 10 between blocks 11, however, gap 41 merely exposes the smooth surface of post 20, thereby maintaining the visual continuity and physical integrity of bordering system 10. Post 20 also thereby serves as a barrier for soil 3, if needed. As demonstrated by FIG. 10, the angle between centerlines C₁ and C₂ may exceed ninety (90°) degrees, being limited only to the angle at which bevels 22 and 32 meet.

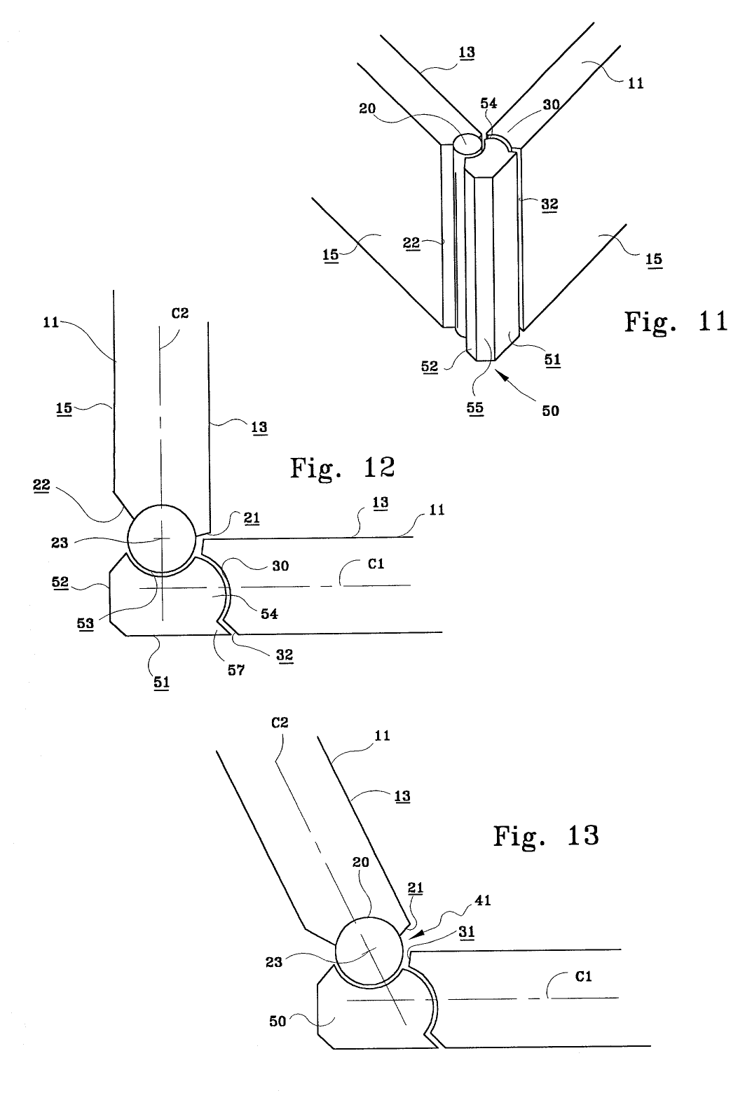

Turning now to FIGS. 11-13, filler block 50 closes a gap that inevitably opens when centerlines C₁ and C₂ form an inside angle greater than that at which bevels 31 and 21 meet. For angles greater than that shown in FIG. 8, adjacent blocks 11 cease to pivot about axis 23 and begin to pivot about the meeting point of bevels 21 and 31. Centerlines C₁ and C₂ no longer intersect at axis 23, but instead intersect at a point beyond the perimeter or surface of post 20 along centerline C₂. As seen in FIGS. 12 and 13, this point of intersection lies within the interior of filler block 50.

Filler block 50 comprises a vertical, fundamentally rectangular cylinder of irregular cross section. Filler block 50 has a height matching that of post 20 and includes rear faces 51 and 52 disposed substantially at right angles to each other, with optional corner bevel 55 between them. Opposite rear face 51, filler block scallop 53 emulates scallop 30 to mate with post 20, allowing post 20 to nest within filler block 50 as it does within end 18 of adjacent block 11 in a straight run. Filler block 50 also includes nose 54 opposite rear face 52 which nests within scallop 30. Tab 57 extends toward bevel 32 to secure filler block 50 in place. In this manner, filler block 50 creates an interface between adjacent blocks 11 which otherwise would touch only at bevels 31 and 21. Filler block 50 creates for sharp inside corners the same interlocking stability that post 20 and scallop 30 otherwise provide, and further stabilizes soil 3.

Turning to FIG. 13, adjacent blocks 11 are shown pivoted relative to each other and employing filler block 50. This causes gap 41 again to open, further causing centerlines C₁ and C₂ to form an obtuse angle the apex of which is not at axis 23, but remains within filler block 50. Such angular configuration would be useful in obtuse, inside corners which, though not quite right angles, are so great that blocks 11 pivot at bevels 21 and 31, preventing post 20 from nesting properly within scallop 30. One having ordinary skill in the art will recognize that some overlap in the angles between centerlines C₁ and C₂ exists where filler block 50 may or may not be employed, as desired. Where gap 41 becomes significant, nose 54 still maintains the visual and physical integrity of bordering system 10. Filler block 50, would be eliminated when the angle between centerlines C₁ and C₂ is slight enough to enable reliable nesting of post 20 directly within scallop 30 again (FIG. 8).

In operation, a user employing bordering system 10 arrays a plurality of blocks 11 end to end along the border of a flower bed, property line, pond, wishing well or other physical object the user wishes to distinguish. Each block 11 is placed adjacent to a previously placed block 11. The user could proceed from either end, either setting leftmost block 11 and then nesting post 20 of right adjacent block 11 inside scallop 30 thereof, or setting rightmost block 11 first and embracing its post 20 with scallop 30 of left adjacent block 11.

In either case, before solidly setting the second of two adjacent blocks 11, the user pivots it about axis 23 so that its front face 13 forms the desired angle with front face 13 of adjacent block 11. Where this angle is less than one hundred eighty (180°) degrees (e.g. FIG. 8), the user would use his judgment as to the need for filler block 50. At the point where bevels 21, 31 meet, the angle between centerlines C₁ and C₂ causes blocks 11 to pivot there instead of at axis 23, and filler block 50 may be needed. As the angle between centerlines C₁ and C₂ increases, the importance of filler block 50 becomes greater, as discussed above.

Where bordering system 10 follows an outside curve, centerlines C₁ and C₂ form an angle as shown in FIGS. 9 and 10. At the point at which bevels 22 and 32 meet, the angle between adjacent blocks 11 has reached a maximum. For more acute, outside angles, the user might wish to turn such corner with two angles formed by three sequential blocks 11 (not shown), thus reducing the angle between two adjacent blocks. As seen in FIGS. 10 and 11, however, the apparatus disclosed above is capable of forming both inside and outside angles in excess of ninety (90°) degrees, which will serve the purpose of most if not all applications.

The user proceeds one block at a time as described until bordering system 10 is completed. Completion in some cases means distinct starting and ending points, and in other cases means that the leading end of the last block 11 placed interfaces with the trailing end of the first block 11 placed, the bordering system having thereby looped back to its beginning point. An example of this would be where a circular flower bed is surrounded with bordering system 10. Where the total path of bordering system 10 is not an even multiple of the length of a block 11, the user must decide whether to shift his arrangement of blocks 11 to lengthen the path of blocks 11 until all fit, or to cut the last placed block to fit. Shifting blocks 11 could require increasing and decreasing angles between pairs of adjacent blocks, or it could require increasing the overall area enclosed by bordering system 10, such as by increasing the radius of a circular border. If the user decides to cut the last placed block 11, he would choose an inconspicuous place to do so, such as a hidden end or corner. Alternately, specialized terminal blocks of various shorter lengths (not shown) could be fabricated to accommodate such fitting adjustments. This could be necessary where, for example, filled, hollow plastic blocks (discussed below) are used for bordering system 10.

Blocks 11 and filler block 50 preferably are fabricated as masonry blocks from a concrete mix of type 1 or type 3 portland cement in combination with sand, water and a plasticizer, with or without gravel as a filler. For more aesthetically pleasing blocks 11, ceramic or terra cotta clay could be substituted. Any such mix optionally includes synthetic reinforcing fibers as needed for strength. Alternately, blocks 11 could be fabricated from a variety of synthetic materials, such as polyethylene, polyvinyl chloride, polypropylene, fiberglass reinforced polyester or epoxy resin, preferably ultraviolet resistant. Such plastic blocks 11 could be solid, but preferably would be rotary cast to form a hollow shell. They then could be provided with a fill hole and plug (not shown) for filling them after installation with water, gravel, sand or other dense fill material to increase their weight and stability. The synthetic plastic blocks may be plain or colored during molding, and could include a polyester filler in the molten plastic to give them a natural stone appearance.

The invention has been described as a border for flowerbeds, gardens, sidewalks and the like. For such applications, blocks 11 preferably are approximately eighteen to twenty-four inches long, one and one-half (1½″) to two (2″) inches thick and vary from eight to twelve inches high. In such size, they each would weigh approximately forty (40) pounds if masonry, and approximately three and one-half (3½) pounds if plastic. Also in such size, bores 12 preferably would be approximately five-eighths inch in diameter, penetrate blocks 11 approximately four inches deep and be separated approximately nine to twelve inches along centerline C. They would be adapted to receive one-half inch vinyl coated steel spikes 4 which would extend approximately four to six inches into soil 3 or other substrate beneath bottom 19. One having ordinary skill in the art will recognize that the sizing and distribution of bores 12 and spikes 4 will vary with the size and weight of blocks 11.

Bordering system 10 thus provides a convenient system of interface between flowerbeds, gardens and other areas to be trimmed, partially concealed or stabilized. Particularly useful with flowerbeds and gardens, interlocking blocks 11 remain aligned vertically because posts 20 nest within scallops 30. This simultaneously keeps a continuous barrier to soil 3 mounded behind rear face 15 of blocks 11 while maintaining an aesthetically pleasing front of contiguous faces 13 interspersed as necessary by gaps 41 filled by posts 20. The invention overcomes the drawbacks of the prior art by preventing breaches of the barrier where blocks must be angled relative to each other, as well as providing an appearance aesthetically preferred over such prior art blocks.

While the invention has been particularly shown and described with reference to a preferred embodiment, it will be understood by those skilled in the art that various changes in form and detail may be made therein without departing from the spirit and scope of the invention. For example, blocks 11 have been described as substantially uniform in thickness. Blocks 11 could be of trapezoidal or other convenient vertical cross section (transverse centerline C), however, as well as varying in thickness along centerline C (neither variation shown). A practical use of such variation about vertical axis V, for example, would lend greater overturning resistance by lowering the center of gravity of blocks 11. Such variation need not be symmetric about axis V, but could present a vertical front face 13 while having a much wider bottom 19 (not shown) than top 16.

Bordering system 10 also is not limited to short flowerbed or garden borders, but could comprise much larger and taller blocks 11 used to form the walls of a well, such as a decorative wishing well or a functional water well. Bordering system 10 also could be even larger and used as a boundary wall or fence several feet high. In such case, where masonry blocks 11 are used, they could be equipped with lifting lugs (not shown) arrayed along their upper perimeter, and reinforced with wire mesh or reinforcing bar within their interior. Also, because of their increased weight in such case, a foundation (not shown) might be installed first, with spikes 4 disposed along its length to serve as anchor bolts for blocks 11.

I claim:

1. A bordering system comprising a plurality of blocks arrayed end to end, each block comprising
a longitudinal body extending between a first end and a second end and having a longitudinal axis;
a front face disposed between the ends;
a cylindrical post disposed on the first end and having a post radius and a post axis;
scallop means disposed on the second end and adapted to receive the cylindrical post of an adjacent block; and
flange means extending said front face in front of said scallop means.

2. The bordering system of claim 1 wherein the scallop means comprises
a concave cavity disposed behind the flange means opposite the front face, the cavity being oriented parallel the cylindrical post and having a scallop axis and a scallop radius substantially matching the post radius.

3. The bordering system of claim 1 wherein
the flange means comprises an extension of the front face adapted to cover at least a portion of the post of an adjacent block.

4. The bordering system of claim 1 wherein
two adjacent blocks are adapted to pivot about said post axis to form an included angle between their front faces.

5. The bordering system of claim 4 wherein each block further comprises
a first bevel disposed between the cylindrical post and the front face;
a second bevel disposed on the flange between the scallop means and the front face;
a third bevel disposed between the cylindrical post and the rear face; and
a fourth bevel disposed between the scallop means and the rear face.

6. The bordering system of claim 5 wherein
said first and second bevels of two adjacent blocks meet at a point of contact where a predetermined included angle is formed between their front faces.

7. The bordering system of claim 6 wherein
the two adjacent blocks pivot about said point of contact when the included angle between said two adjacent blocks is less than the predetermined included angle.

8. The bordering system of claim 7 and further comprising
a filler block having
a nose received within the scallop of one of the blocks; and
a recess receiving the cylindrical post of the other block whereby said filler block nests between the juxtaposed ends of the two adjacent blocks and fills a void formed when the front faces of the blocks form an included angle less than the predetermined included angle.

9. The bordering system of claim 4 and further comprising
a plurality of filler blocks, each having
a nose adapted to be received within the scallop of one of a first block; and
a recess adapted to receive the cylindrical post of a second block, said filler blocks being nested between the ends of selected pairs of adjacent blocks, the blocks being selected because their front faces form an included angle less than a predetermined angle.

10. The bordering system of claim 1 and further comprising
a plurality of bores in a bottom edge of each block for receiving braces which extend from the bores to penetrate a substrate on which the block rests.

11. The bordering system of claim 10 wherein
the substrate comprises a foundation; and
the braces comprise anchor pins embedded into the foundation and protruding vertically upward into the bores of each block.

12. The bordering system of claim 1 and further comprising
a longitudinally central cornice disposed on a top edge of the body of each block.

13. The bordering system of claim 1 wherein the blocks comprise
plastic containers having
a hollow interior adapted to receive fill material; and
an access hole; and
a removable plug.

14. The bordering system of claim 1 wherein the blocks comprise
fiber reinforced masonry.

15. A method of creating a decorative border, the method comprising
providing a plurality of blocks, each block having
a front face and a rear face;
a longitudinal axis extending between a first end and a second end;
a cylindrical post disposed on the first end and having a post axis;
a scallop disposed on the second end and having a scallop axis; and
a flange extending parallel the longitudinal axis from said front face to a point in front of said scallop; then
arranging said blocks end to end along a predetermined path to form the border;
nesting the cylindrical post of each block within the scallop of an adjacent block;
pivoting longitudinally each block relative to the adjacent block as needed to adhere to a predetermined path of the decorative border;
terminating the decorative border.

16. The method of claim 15 wherein the step of pivoting further comprises
providing a filler block having
a nose adapted to nest with a scallop; and
a recess adapted to receive a cylindrical post; then
determining whether or not any void between two adjacent blocks is sufficiently large to require a filler block; then
filling said sufficiently large void with a filler block by
nesting the post of one block into the recess;
nesting the nose of the filler block into the scallop of the adjacent block;
aligning the filler block elevation to match that of the adjacent blocks; then
adjusting as necessary the position of the adjacent blocks to minimize any remaining void.

17. The method of claim 15 wherein the step of terminating the decorative border comprises
cutting one or more blocks to fit a remainder of the predetermined path after said plurality of blocks have been installed.

18. The method of claim 15 and further comprising the steps of
embedding a lower edge of said plurality of blocks a predetermined depth below a surface on which said border rests.

19. The method of claim 18 and further comprising the steps of
mounding soil against the rear face of one or more of the blocks.

20. A edging system for a garden having a perimeter, the edging system comprising
a plurality of blocks disposed end to end along the perimeter and resting upon a substrate, the blocks being oriented at longitudinal angles relative to each other, each block having
a front face bearing a decoration;
a rear face opposite the front face and disposed toward the garden;
a longitudinal axis extending between a first end and a second end parallel said faces;
a bottom edge substantially parallel said longitudinal axis and having a plurality of vertical bores extending into an interior of the block;
a top edge opposite the bottom edge and including a longitudinally central cornice;
a flange extending from the front face longitudinally toward the front face of an adjacent block;
a concave scallop disposed on the rear face at the first end and behind the flange, the scallop having a scallop axis;
a cylindrical post having a post axis and disposed on the second end and adapted to be received coaxially within the scallop of an adjacent block; and
spikes extending from the substrate into the bores of each block;
a plurality of filler blocks, each having
a nose adapted to nest within the scallop; and
a recess adapted to receive the post,
each filler block being disposed between the juxtaposed post and scallop of a selected pair of adjacent blocks the longitudinal angle between which prevents the post of one of the pair of blocks from nesting within the scallop of the other of the pair of blocks.
